(19) United States
(12) Patent Application Publication
(10) Pub. No.: US 2014/0343240 A1
(43) Pub. Date: Nov. 20, 2014

(54) POLY(CARBOXYLIC ACID)-BASED POLYMER FOR HYDRAULIC MATERIAL ADDITIVE

(71) Applicants: Masahiro Sato, Osaka (JP); Takashi Tomita, Osaka (JP)

(72) Inventors: Masahiro Sato, Osaka (JP); Takashi Tomita, Osaka (JP)

(73) Assignee: NIPPON SHOKUBAI CO., LTD., Osaka-shi, Osaka (JP)

(21) Appl. No.: 14/344,276

(22) PCT Filed: Sep. 11, 2012
(86) PCT No.: PCT/JP2012/073118

§ 371 Date: Mar. 11, 2014

(30) Foreign Application Priority Data
Sep. 12, 2011 (JP) 2011-198062

(51) Int. Cl. C04B 16/04

(52) U.S. Cl. CPC C04B 16/04
USPC 526/318.42

(57) ABSTRACT

The present invention provides a poly(carboxylic acid) polymer for a hydraulic material additive excellent in dispersion performance for a hydraulic material, workability, and stability of quality and also provides a hydraulic material additive containing the poly(carboxylic acid) polymer, and a hydraulic material.

The present invention is a poly(carboxylic acid) polymer for a hydraulic material additive, wherein the polymer has a (poly)alkylene glycol chain, and the polymer has a weight average molecular weight (Mw) of 30000 or less, and an amount of a thiol group in the polymer of 2.4 μmol/g or less.

### TECHNICAL FIELD

The present invention relates to a poly(carboxylic acid) polymer for a hydraulic material additive. More specifically, the present invention relates to a poly(carboxylic acid) polymer for a hydraulic material additive, a hydraulic material additive containing the poly(carboxylic acid) polymer for a hydraulic material additive, and a hydraulic material.

### BACKGROUND ART

A hydraulic material additive is an additive used for a hydraulic material such as cement, mortar, concrete, and gypsum, and, for example, a water-reducing agent having water-reducing ability is representative, and such a hydraulic material additive is an essential additive to construct a civil engineering/architectural structure or the like from a hydraulic material. Above all, the water-reducing agent enhances fluidity of the hydraulic material, reduces water from a cement composition, and thereby has a function of improving strength, durability, or the like of a hardened product. Examples of the water-reducing agent include a concrete admixture and a dispersant for gypsum, and a concrete admixture containing a poly(carboxylic acid) polymer is disclosed in, for example, Patent Literature 1. Such a concrete admixture containing a poly(carboxylic acid) polymer exhibits higher water-reducing ability compared with the conventional water-reducing agent of naphthalene-base or the like and therefore has enough of a track record as a high-performance AE water-reducing agent.

### CITATION LIST

### Patent Literature

Patent Literature 1: JP 58-74552 A

### SUMMARY OF INVENTION

### Technical Problem

It is useful to use a poly(carboxylic acid) polymer as a hydraulic material additive as described above, and a thiol chain transfer agent is widely used to mainly adjust the molecular weight in producing the poly(carboxylic acid) polymer. However, the thiol chain transfer agent has a good effect in adjusting the molecular weight but sometimes remains after polymerization. When the thiol chain transfer agent remains in a product, it sometimes occurs that the thiol chain transfer agent gives off a bad smell and a working environment does not become favorable in actually producing concrete or a gypsum board using the thiol chain transfer agent. Moreover, when a hydraulic material additive is obtained using a poly(carboxylic acid) polymer, the poly(carboxylic acid) polymer is usually blended with various components other than the poly(carboxylic acid) polymer such as an agent for adjusting the amount of air, an accelerator, and a retarder, however when the thiol chain transfer agent remains in the poly(carboxylic acid) polymer, there has been a possibility that the thiol chain transfer agent reacts with the components other than the polymer and an unfavorable gas or the like is generated. Furthermore, there has also been a possibility that a product such as a disulfide compound that can be generated by the remaining thiol chain transfer agent reacting with a component other than the polymer affects the performance as a hydraulic material additive.

The present invention has been made in consideration of the above-described current situation, and an object of the present invention is to provide a poly(carboxylic acid) polymer for a hydraulic material additive excellent in dispersion performance for a hydraulic material, workability, and stability of quality, and also to provide a hydraulic material additive containing the poly(carboxylic acid) polymer for a hydraulic material additive, and a hydraulic material.

### Solution to Problem

The present inventors have made various studies on the poly(carboxylic acid) polymer useful for the hydraulic material additive to find out that, when a poly(carboxylic acid) polymer having a (poly)alkylene glycol chain is used, properties such as hydrophilicity, hydrophobicity, and steric repulsion are imparted to the poly(carboxylic acid) polymer by appropriately adjusting the chain length of the (poly)alkylene glycol chain and an alkylene oxide that constitutes the (poly)alkylene glycol, and therefore the poly(carboxylic acid) polymer becomes preferred for use in a hydraulic material additive; that when the weight average molecular weight of the poly(carboxylic acid) polymer is within a predetermined range, the performance of retaining fluidity or the viscosity of a composition containing a hydraulic material (also referred to as a hydraulic material composition) becomes appropriate; and that when the amount of a thiol group in the poly(carboxylic acid) polymer is within a predetermined range, a working environment in handling the poly(carboxylic acid) polymer becomes favorable and the performance of the poly(carboxylic acid) polymer can be stably exhibited. And the present inventors have found that a poly(carboxylic acid) polymer having a polyalkylene glycol chain, a weight average molecular weight (Mw) within the predetermined range, and an amount of the thiol group within the predetermined range becomes useful for, in particular, a hydraulic material additive, and the present inventors have conceived that the problem can be perfectly solved. Moreover, the present inventors have also found that, in the method for producing the poly(carboxylic acid) polymer, the poly(carboxylic acid) polymer in which the amount of the residual thiol group is reduced to a predetermined range can be suitably obtained by making a ratio of addition time of a polymerization initiator to addition time of a thiol chain transfer agent a predetermined value or more or by increasing the polymerization temperature, and the presentment inventors have reached the present invention.

Namely, the present invention is a poly(carboxylic acid) polymer for a hydraulic material additive, wherein the polymer has a (poly)alkylene glycol chain, and the polymer has a weight average molecular weight (Mw) of 30000 or less, and an amount of a thiol group in the polymer of 2.4 μmol/g or less. In addition, preferably, the thiol group in the polymer is derived from a thiol chain transfer agent. Furthermore, preferably, the weight average molecular weight of the polymer is 10000 or less.

The present invention is also a hydraulic material additive containing the poly(carboxylic acid) polymer for a hydraulic material additive.

Furthermore, the present invention is also a hydraulic material containing the hydraulic material additive.

Hereinafter, the present invention will be described in detail.

In addition, an embodiment combining two or three or more individual preferable embodiments of the present invention to be described hereinafter is also a preferable embodiment of the present invention.

### [Poly(Carboxylic Acid) Polymer for Hydraulic Material Additive]

The poly(carboxylic acid) polymer for a hydraulic material additive of the present invention (hereinafter, also referred to as “poly(carboxylic acid) polymer” or “polymer”) has an amount of the thiol group in the polymer (1 g) is 2.4 μmol/g or less. The working environment in actual use can be made favorable by the amount of the thiol group in the polymer being within the range, and it becomes possible that the performance derived from the polymer can be stably exhibited. The amount of the thiol group is more preferably 0.95 μmol/g or less, further more preferably 0.5 μmol/g or less, particularly preferably 0.25 μmol/g or less, most preferably 0.05 μmol/g or less.

It is preferred that the thiol group in the poly(carboxylic acid) polymer is a thiol group (SH group) derived from a thiol group-containing compound used at the time of producing the polymer. Above all, it is preferable that the thiol group is a thiol group derived from a thiol chain transfer agent. As described here, an embodiment in which the thiol group in the polymer is a thiol group derived from a thiol chain transfer agent is also one of the preferred embodiments of the present invention.

In addition, “the amount of a thiol group in the polymer” can be calculated by quantitatively measuring the amount of a residual thiol group-containing compound (preferably, a thiol chain transfer agent) used at the time of producing the polymer by, for example, high performance liquid chromatography (LC) as described later. In the present invention, it is also preferred that a thiol group-containing compound (preferably a thiol chain transfer agent) is not used at the time of producing the polymer, and when the thiol group-containing compound is not used, the amount of the thiol group in the polymer becomes 0 μmol/g.

It is preferred that the poly(carboxylic acid) polymer also has an amount of the thiol chain transfer agent in the polymer of 250 ppm or less. It becomes possible to make the working environment in actual use more favorable, and it also becomes possible that the performance derived from the polymer can be exhibited more stably by the amount of the thiol chain transfer agent in the polymer being within the range of 250 ppm or less. As described here, an embodiment in which the amount of the thiol chain transfer agent in the polymer is 250 ppm or less is also one of the preferred embodiments of the present invention. The amount of the thiol chain transfer agent in the polymer is more preferably 100 ppm or less, further more preferably 50 ppm or less, particularly preferably 25 ppm or less, most preferably 5 ppm or less. An embodiment in which the amount of the thiol chain transfer agent in the polymer is 0 ppm is also preferable.

In addition, the amount of the thiol chain transfer agent in the polymer can be calculated by carrying out quantitative measurement by, for example, high performance liquid chromatography (LC) as described later.

The poly(carboxylic acid) polymer also has a weight average molecular weight (Mw) of 30000 or less. The retention properties of the fluidity and the viscosity of the hydraulic material composition such as a cement composition and a gypsum composition are made favorable by Mw being within the range of 30000 or less. Mw is preferably 10000 or less. As described here, an embodiment in which the polymer has a weight average molecular weight of 10000 or less is one of the preferred embodiments of the present invention. Mw is more preferably 9500 or less, more preferably 9200 or less, particularly preferably 9000 or less, most preferably 8800 or less. Moreover, from the standpoint that the poly(carboxylic acid) polymer can exhibit the performance more easily as the poly(carboxylic acid) polymer is adsorbed on a hydraulic material particle such as a cement particle and a gypsum particle to some extent and the adsorption ability becomes stronger as Mw is larger, Mw is preferably 2000 or more. Mw is more preferably 3000 or more, further more preferably 4000 or more, particularly preferably 4500 or more, most preferably 5000 or more.

Moreover, the molecular weight distribution of the poly(carboxylic acid) polymer, namely the value (Mw/Mn) obtained by dividing the weight average molecular weight (Mw) by the number average molecular weight (Mn), is preferably 1.5 or less. The polymer content that has no effect on the dispersibility can be reduced more by the molecular weight distribution being 1.5 or less, and therefore it becomes possible to enhance the dispersibility for the hydraulic material such as cement and gypsum more. More preferably, the molecular weight distribution is 1.45 or less.

As used herein, the molecular weight is a molecular weight value in terms of polyethylene glycol measured by gel permeation chromatography (GPC) and is measured under the following condition.

### <GPC Measurement Condition>

Column to be used: TSK guard column SWXL+TSKgel G4000SWXL+G3000SWXL+G2000SWXL manufactured by Tosoh Corporation;
Eluent: a solution obtained by dissolving 115.6 g of sodium acetate trihydrate in a mixed solvent of 10999 g of water and 6001 g of acetonitrile and further adjusting the pH to 6.0 with acetic acid is used;
Amount of sample injected: 100 μL;
Flow rate: 1.0 mL/min;
Column temperature: 40° C.;
Detector: 2414 differential refractive index detector manufactured by Nihon Waters K.K.;
Analyzing Software: Empower Software+GPC option manufactured by Nihon Waters K.K.;
Standard material for making calibration curve: polyethylene glycols [peak top molecular weight (Mp) 272500, 219300, 107000, 50000, 24000, 12600, 7100, 4250, and 1470];
Calibration curve: a calibration curve is made by a cubic equation based on the Mp values and elution times of the polyethylene glycols;

A solution in which a polymer aqueous solution is dissolved by the eluent so that the concentration of the polymer becomes 0.5 mass % is used as a sample.

### <Analysis of Molecular Weight>

A polymer is detected/analyzed in an obtained RI chromatogram by connecting the parts where a baseline just before and immediately after the elution of the polymer is stable in flat to each other by a straight line.

However, when a monomer or an impurity or the like derived from a monomer is measured partially overlapped with the polymer peak, the molecular weight and the molecular weight distribution of only the polymer portion are measured by separating the polymer portion from the monomer portion by vertically dividing the most recessed part in the overlapping part of the monomer or impurity or the like and the polymer. When the peak of the polymer and the peak of a compound other than the polymer are completely overlapped and cannot be separated, the calculation is carried out altogether.

The poly(carboxylic acid) polymer also has a (poly)alkylene glycol chain. It is preferred to use an unsaturated monomer having a (poly)oxyalkylene group for incorporating the (poly)alkylene glycol chain in the polymer. Namely, it is preferred that the polymer is obtained by polymerizing a monomer component containing an unsaturated monomer having a (poly)oxyalkylene group. Above all, more preferably, the polymer is a polymer (copolymer) obtained by polymerizing a monomer component containing an unsaturated monomer having a (poly)oxyalkylene group and an unsaturated carboxylic acid monomer. In addition, each monomer may be used singly or in combinations of two or more.

As used herein, the “(poly)oxyalkylene group” means a polyoxyalkylene group or an alkylene group, and the “(poly)alkylene glycol chain” means a polyalkylene glycol chain or an alkylene glycol chain.

### <Unsaturated Monomer Having (Poly)Oxyalkylene Group>

The unsaturated monomer having a (poly)oxyalkylene group may be an unsaturated monomer having a polymerizable unsaturated group and a (poly)alkylene glycol chain, and it is preferred that the unsaturated monomer having a (poly)oxyalkylene group is, for example, a compound represented by the following general formula (1). As described here, an embodiment in which the unsaturated monomer having a (poly)oxyalkylene group is a compound represented by the following general formula (1) is also one of the preferred embodiments of the present invention.

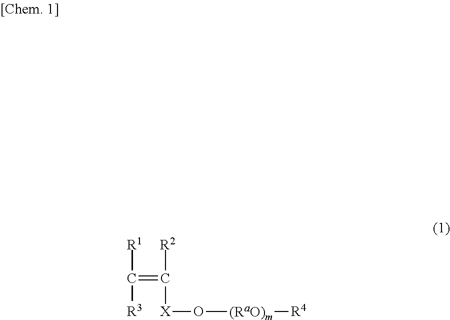

In the general formula (1), R¹, R², and R³ are the same or different and represent a hydrogen atom or a methyl group. R⁴ represents a hydrogen atom or a hydrocarbon group having 1 to 20 carbon atoms. R^{a} are the same or different and represent an alkylene group having 2 to 18 carbon atoms. m represents an average addition number of moles of an oxyalkylene group represented by R^{a}O and is a number of 1 to 300. X represents a divalent alkylene group having 1 to 5 carbon atoms, represents a —CO— bond, or, when a group represented by R¹R³C═CR²— is a vinyl group, represents that the carbon atom and the oxygen atom bonded to X are directly bonded with each other. Namely, X represents any one of a divalent alkylene group having 1 to 5 carbon atoms, a —CO— bond, or a direct bond (when the group represented by R¹R³C═CR²— is a vinyl group).

In addition, when two or more of the oxyalkylene groups represented by R^{a}O exist in the same monomer, the oxyalkylene groups may be any addition form of random addition, block addition, alternating addition, and so on.

In the general formula (1), R⁴ represents a hydrogen atom or a hydrocarbon group having 1 to 20 carbon atoms. When the number of carbon atoms exceeds 20, there is a possibility that the cement composition cannot obtain more favorable dispersibility. A preferable embodiment of R⁴ is a hydrogen atom or a hydrocarbon group having 1 to 20 carbon atoms from the standpoint of dispersibility. R⁴ is more preferably a hydrocarbon group having 10 or less carbon atoms, further more preferably a hydrocarbon group having 3 or less carbon atoms, particularly preferably a hydrocarbon group having 2 or less carbon atoms. Among hydrocarbon groups, a saturated alkyl group and an unsaturated alkyl group are preferable, and the saturated alkyl group and the unsaturated alkyl group may be linear or branched. Moreover, R⁴ is preferably a hydrocarbon having 5 or more carbon atoms and is preferably a hydrocarbon group having 20 or less carbon atoms to exhibit excellent material separation prevention performance or make the amount of air carried within the cement composition appropriate. More preferably, R⁴ is a hydrocarbon group having 5 to 10 carbon atoms. Among hydrocarbon groups, a saturated alkyl group and an unsaturated alkyl group is preferable, and the saturated alkyl group and the unsaturated alkyl group may be linear or branched.

In the general formula (1), the (poly)alkylene glycol chain represented by —(R^{a}O)ₘ— may be a chain constituted from one or two or more alkylene oxides having 2 to 18 carbon atoms. Examples of the alkylene oxide include ethylene oxide, propylene oxide, butylene oxide, isobutylene oxide, 1-butene oxide, and 2-butene oxide. Among the (poly)alkylene glycol chains, a chain mainly constituted from an alkylene oxide having 2 to 8 carbon atoms is preferable, a chain mainly constituted from an alkylene oxide having 2 to 4 carbon atoms such as ethylene oxide, propylene oxide, and butylene oxide are more preferable, and a chain mainly constituted from ethylene oxide is further more preferable.

“Mainly” here means that when the polyalkylene glycol chain —(R^{a}O)ₘ— is constituted from two or more alkylene oxides, an alkylene oxide accounts for most of the alkylene oxides in the number of all existing alkylene oxides. When “accounting for most of the alkylene oxides” is represented by a mol % of the ethylene oxide based on 100 mol % of all the alkylene oxides, 50 to 100 mol % is preferable. Thereby, the polymer has higher hydrophilicity. The mol % is more preferably 60 mol % or more, more preferably 70 mol % or more, further more preferably 80 mol % or more, most preferably 90 mol % or more.

Moreover, when X in the general formula (1) represents a —CO— bond, it is preferred that the compound represented by the general formula (1) is a (poly)alkylene glycol ester monomer. When X is a (poly)alkylene glycol ester monomer, it is preferred from the standpoint of improving the productivity of esterification with a (meth)acrylic acid monomer (R¹R³C═CR²—COOH) that an ethylene glycol part is added to the ester bond part of the (poly)alkylene glycol chain represented by —(R^{a}O)ₘ— with the (meth)acrylic acid monomer.

In the formula —(R^{a}O)ₘ₋—, m is the average addition number of moles of the oxyalkylene group represented by R^{a}O, and m is preferably a number of 1 to 300 in the poly(carboxylic acid) polymer to be produced. When m exceeds 300, there is a possibility that the polymerizability of the monomer does not become sufficient. m is preferably 2 or more, and the average addition number of moles of an oxyethylene group in the formula —(R^{a}O)ₘ— is preferably 2 or more. As described here, when m is 2 or more, or the average addition number of moles of the oxyethylene group is 2 or more, more sufficient hydrophilicity and steric hindrance for dispersing a cement particle or the like are obtained, and therefore more excellent fluidity can be obtained. It is more preferable in order to obtain excellent fluidity that m is 3 or more, further more preferably 10 or more, particularly preferably 20 or more, and more preferably, m is 280 or less, further more preferably 250 or less, particularly preferably 150 or less. Further, the average addition number of moles of the oxyethylene group is preferably 3 or more, further more preferably 10 or more, particularly preferably 20 or more, and more preferably, the average addition number of moles of the oxyethylene group is 280 or less, further more preferably 250 or less, particularly preferably 150 or less. On the other hand, in order to obtain concrete having a low viscosity, m is preferably 3 or more, more preferably 4 or more, particularly preferably 5 or more, and more preferably, m is 100 or less, further more preferably 50 or less, particularly preferably 30 or less.

In addition, the average addition number of moles means the average value of the number of moles of the added organic group in 1 mole of a monomer.

The unsaturated monomer having a (poly)oxyalkylene group can be used in combination of two or more monomers each having a different average addition number of moles m of the oxyalkylene group. Examples of the preferred combination include a combination of two unsaturated monomers each having a (poly)oxyalkylene group the difference of m of which unsaturated monomers is 10 or less (preferably 5 or less); a combination of two unsaturated monomers each having a (poly)oxyalkylene group the difference of m of which unsaturated monomers is 10 or more (preferably 20 or more); and a combination of three or more unsaturated monomers each having a (poly)oxyalkylene group the differences of each average addition number of moles m of which unsaturated monomers are 10 or more (preferably 20 or more). Moreover, as the range of m to be combined, a combination of an unsaturated monomer having a polyoxyalkylene group of which average addition number of moles m is within the range of 40 to 300 and an unsaturated monomer having a (poly)oxyalkylene group of which average addition number of moles m is within the range of 1 to 40 (provided that the difference of m is 10 or more, preferably 20 or more); a combination of an unsaturated monomer having a polyoxyalkylene group of which average addition number of moles m is within the range of 20 to 300 and an unsaturated monomer having a (poly)oxyalkylene group of which average addition number of moles m is within the range of 1 to 20 (provided that the difference of m is 10 or more, preferably 20 or more), and so on are possible.

It is preferred that the compound represented by the general formula (1) is, for example, a (poly)alkylene glycol adduct of an unsaturated alcohol or a (poly)alkylene glycol ester monomer.

The (poly)alkylene glycol adduct of an unsaturated alcohol may be a compound having a structure in which a (poly)alkylene glycol chain is added to an alcohol having an unsaturated group. For example, alkylene oxide adducts of vinyl alcohol, alkylene oxide adducts of (meth)allyl alcohol, alkylene oxide adducts of 3-butene-1-ol, alkylene oxide adducts of isoprene alcohol (3-methyl-3-butene-1-ol), alkylene oxide adducts of 3-methyl-2-butene-1-ol, alkylene oxide adducts of 2-methyl-3-butene-2-ol, alkylene oxide adducts of 2-methyl-2-butene-1-ol, and alkylene oxide adducts of 2-methyl-3-butene-1-ol are preferred.

Moreover, as the polyalkylene glycol adduct of an unsaturated alcohol, polyethylene glycol monovinylether, polyethylene glycol monoallylether, polyethylene glycol mono(2-methyl-2-propenyl)ether, polyethylene glycol mono(2-butenyl)ether, polyethylene glycol mono(3-methyl-3-butenyl)ether, polyethylene glycol mono(3-methyl-2-butenyl)ether, polyethylene glycol mono(2-methyl-3-butenyl)ether, polyethylene glycol mono(2-methyl-2-butenyl)ether, polyethylene glycol mono(1,1-dimethyl-2-propenyl)ether, polyethylene polypropylene glycol mono(3-methyl-3-butenyl)ether, methoxy polyethylene glycol mono(3-methyl-3-butenyl)ether, and so on are preferred.

The (poly)alkylene glycol ester monomer may be a monomer having a structure in which an unsaturated group and a (poly)alkylene glycol chain are bonded through an ester bond, and an unsaturated carboxylic acid polyalkylene glycol ester compound is preferred. Among the unsaturated carboxylic acid polyalkylene glycol ester compounds, an (alkoxy) (poly)alkylene glycol mono(meth)acrylate is preferred.

As the (alkoxy)(poly)alkylene glycol mono(meth)acrylate, for example, an esterified product of an alkoxy(poly)alkylene glycol in which 1 to 300 moles of an alkylene oxide group having 2 to 18 carbon atoms is added to an alcohol with (meth)acrylic acid is preferred. It is particularly preferable that the alkoxy(poly)alkylene glycol is an alkoxy(poly)alkylene glycol mainly constituted from ethylene oxide.

Examples of the alcohol include an aliphatic alcohols having 1 to 30 carbon atoms such as methanol, ethanol, 1-propanol, 2-propanol, 1-butanol, 2-butanol, 1-pentanol, 2-pentanol, 3-pentanol, 1-hexanol, 2-hexanol, 3-hexanol, octanol, 2-ethyl-1-hexanol, nonyl alcohol, lauryl alcohol, cetyl alcohol, and stearyl alcohol; alicyclic alcohols having 3 to 30 carbon atoms such as cyclohexanol; and unsaturated alcohols having 3 to 30 carbon atoms such as (meth)allyl alcohol, 3-butene-1-ol, 3-methyl-3-butene-1-ol, and one or two or more thereof can be used.

As the esterified product, specifically, (alkoxy)polyethylene glycol (poly)(alkylene glycol having 2 to 4 carbon atoms) (meth)acrylic acid esters such as methoxy polyethylene glycol mono(meth)acrylate, methoxy {polyethylene glycol (poly)propylene glycol}mono(meth)acrylate, methoxy {polyethylene glycol (poly)butylene glycol}mono(meth)acrylate, and methoxy(polyethylene glycol (poly)propylene glycol (poly)butylene glycol) mono(meth)acrylate are preferred.

As the (alkoxy) (poly)alkylene glycol mono(meth)acrylate, phenoxy polyethylene glycol mono(meth)acrylate, phenoxy {polyethylene glycol (poly)propylene glycol} mono(meth)acrylate, phenoxy {polyethylene glycol (poly)butylene glycol} mono(meth)acrylate, phenoxy {polyethylene glycol (poly)propylene glycol (poly)butylene glycol} mono(meth)acrylate, (meth)allyloxy polyethylene glycol mono(meth)acrylate, (meth)allyloxy {polyethylene glycol (poly)propylene glycol} mono(meth)acrylate, (meth)allyloxy {polyethylene glycol (poly)butylene glycol} mono(meth)acrylate, and (meth)allyloxy {polyethylene glycol (poly)propylene glycol (poly)butylene glycol} mono(meth)acrylate are preferred in addition to the above-described compounds.

As the unsaturated monomer having a (poly)oxyalkylene group, an (alkoxy)(poly)alkylene glycol monomaleic acid ester, an (alkoxy)(poly)alkylene glycol dimaleic acid ester, and so on are also preferred in addition to the above-described compounds. As the unsaturated monomer having a (poly)oxyalkylene group, the following monomers and so on are preferred.

A half ester and a diester of an alkyl polyalkylene glycol in which 1 to 300 moles of an oxyalkylene having 2 to 4 carbon atoms is added to an alcohol having 1 to 22 carbon atoms or an amine having 1 to 22 carbon atoms with an unsaturated dicarboxylic acid monomer; a half ester and a diester of an unsaturated dicarboxylic acid monomer with an polyalkylene glycol having an average addition number of moles of a glycol having 2 to 4 carbon atoms of 2 to 300; (poly)alkylene glycol di(meth)acrylates such as triethylene glycol di(meth)acrylate, (poly)ethylene glycol di(meth)acrylate, polypropylene glycol di(meth)acrylate, and (poly)ethylene glycol (poly)propylene glycol di(meth)acrylate; and (poly)alkylene glycol dimaleates such as triethylene glycol dimaleate and polyethylene glycol dimaleate.

### <Unsaturated Carboxylic Acid Monomer>

The unsaturated carboxylic acid monomer may be a monomer having a polymerizable unsaturated group and a group capable of forming a carboxyl group. For example, an unsaturated monocarboxylic acid monomer and an unsaturated dicarboxylic acid monomer are preferred. Above all, the unsaturated monocarboxylic acid monomer is more preferable. As described here, an embodiment in which the unsaturated carboxylic acid monomer is an unsaturated monocarboxylic acid monomer is one of the preferred embodiments of the present invention.

The unsaturated monocarboxylic acid monomer may be a monomer having one unsaturated group and one group capable of forming a carboxyl group in the molecule, and it is preferred that the unsaturated monocarboxylic acid monomer is, for example, a compound represented by the following general formula (2).

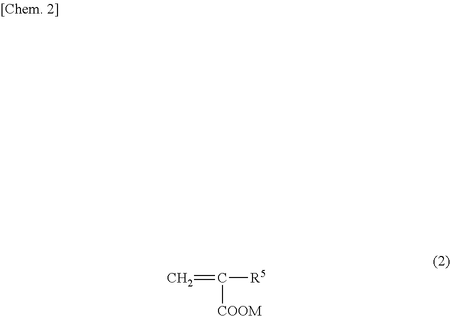

In the general formula (2), R⁵ represents a hydrogen atom or a methyl group. M represents a hydrogen atom, a metal atom, an ammonium group, or an organic amine group (organic ammonium group).

Here, as the metal atom, for example, monovalent metal atoms such as alkali metal atoms such as lithium, sodium, and potassium; divalent metal atoms such as alkaline earth metal atoms such as calcium and magnesium; and trivalent metal atoms such as aluminum and iron are preferred. Moreover, as the organic amine group, alkanolamine groups such as an ethanolamine group, a diethanolamine group, and a triethanolamine group, and a triethylamine group are preferred. Furthermore, the organic amine group may also be an ammonium group.

As the unsaturated monocarboxylic acid monomer, for example, acrylic acid, methacrylic acid, and crotonic acid; and monovalent metal salts, divalent metal salts, ammonium salts, or organic salts (organic ammonium salts) thereof are preferred. Among these unsaturated monocarboxylic acid monomers, it is preferable from the standpoint of improving dispersion performance for cement to use methacrylic acid, and monovalent salts, divalent salts, or ammonium salts and/or organic amine salts thereof (these are also collectively referred to as “methacrylic acid and/or salts thereof”), the methacrylic acid and/or salts thereof is particularly preferred as the unsaturated carboxylic acid monomer.

The unsaturated dicarboxylic acid monomer may be a monomer having one unsaturated group and two groups capable of forming a carboxyl group, and, for example, maleic acid, itaconic acid, citraconic acid, fumaric acid, and so on, and monovalent metal salts, divalent metal salts, ammonium salts, and organic amine salts thereof, and so on, or anhydrides thereof are preferred. It is also preferred to use, in addition to these unsaturated dicarboxylic acid monomers, a half ester of an unsaturated dicarboxylic acid monomer with an alcohol having 1 to 22 carbon atoms; a half amide of an unsaturated dicarboxylic acid with an amine having 1 to 22 carbon atoms; a half ester of an unsaturated carboxylic acid monomer with a glycol having 2 to 4 carbon atoms; and a half amide of maleamic acid and a glycol having 2 to 4 carbon atoms.

### <Other Unsaturated Monomers>

The monomer component used for forming the poly(carboxylic acid) polymer may also contain one or two or more other unsaturated monomers as necessary other than the above-described unsaturated monomer having a (poly)oxyalkylene group and the unsaturated carboxylic acid monomer.

As the other unsaturated monomers, for example, a (meth)acrylic acid ester monomer and an ethylene monomer having a multibranched polyoxyalkylene group are preferred.

As the (meth)acrylic acid ester monomer, for example, an alkyl(meth)acrylate having an alkyl group having 1 to 10 carbon atoms is preferred. Above all, an alkyl(meth)acrylate having an alkyl group having 1 to 4 carbon atoms is preferable, and examples thereof include methyl(meth)acrylate, ethyl(meth)acrylate, butyl(meth)acrylate, and propyl(meth)acrylate. More preferably, the (meth)acrylic acid ester monomer is methyl(meth)acrylate.

Examples of the ethylene monomer having a multibranched polyoxyalkylene group include (1) a macromer obtained by adding glycidyl methacrylate to a multibranched polymer obtained by adding an alkylene oxide to a polyalkylene imine, (2) a (meth)acrylic acid ester macromer of a multibranched polymer obtained by adding an alkylene oxide to a polyalkylene imine, and (3) a maleic acid ester macromer of a multibranched polymer obtained by adding an alkylene oxide to a polyalkylene imine. In addition, as the multibranched polymer, a polyamide polyamine may be used or a multibranched polymer obtained by adding an alkylene oxide to a polyhydric alcohol may be used.

The polyalkylene imine may be a compound having a polyalkylene imine chain constituted from one or two or more alkylene imines, and the polyalkylene imine chain may be any one of a straight chain structure, a branched structure, and a structure that is three-dimensionally crosslinked. Moreover, the weight average molecular weight of the polyalkylene imine is preferably 100 to 100000, more preferably 300 to 50000, further more preferably 600 to 10000.

The alkylene oxide is preferably the same as the alkylene oxide described above, and the average addition number of moles of the oxyalkylene group is preferably made 1 or more and 300 or less. When the average addition number of moles of the oxyalkylene group is within the range, it is possible to make the hydrophilicity of the polymer that is intended to be produced more sufficient. The average addition number of moles of the oxyalkylene group is more preferably 2 or more, further more preferably 3 or more, and the average addition number of moles of the oxyalkylene group is more preferably 200 or less, further more preferably 150 or less, particularly preferably 100 or less, most preferably 50 or less.

The poly(carboxylic acid) polymer of the present invention is preferably obtained by, for example, polymerizing the above-described monomer component under the presence of a polymerization initiator. Namely, it is preferred to obtain the poly(carboxylic acid) polymer by a production method comprising a polymerization step of polymerizing the monomer component under the presence of a polymerization initiator.

As the polymerization initiator, for example, persulfates such as ammonium persulfate, sodium persulfate, and potassium persulfate; hydrogen peroxide; azo compounds such as azo-bis-2-methylpropionamidine hydrochloride and azoisobutyronitrile; and peroxides such as benzoyl peroxide, lauroyl peroxide, and cumene hydroperoxide are preferred. Moreover, a reducing agent such as sodium hydrogen sulfite, sodium sulfite, Mohr's salt, sodium metabisulfite, sodium formaldehyde sulfoxylate, or ascorbic acid; an amine compound such as ethylenediamine, ethylenediaminetetraacetate, or glycine; or the like can also be used as an accelerator together with the polymerization initiator. These polymerization initiators and accelerators may each be used singly or in combinations of two or more.

In the polymerization step, it is preferred that the amount of the polymerization initiator is adjusted or a chain transfer agent is used for the purpose of adjusting the molecular weight of the poly(carboxylic acid) polymer of the present invention. Namely, it is preferred in the present invention that any one or both of the method of adjusting the amount of the polymerization initiator and the method of using the chain transfer agent are adopted. In addition, the chain transfer agent can be used singly or in combinations of two or more.

Various compounds are known as the chain transfer agent, however it is preferred to use a thiol chain transfer agent from an industrial point of view. The thiol chain transfer agent is an organic compound having at least one SH group. Examples of the thiol chain transfer agent include a hydrophobic thiol chain transfer agent and a hydrophilic thiol chain transfer agent, and any one of these thiol chain transfer agents may be used singly or these thiol chain transfer agents may be used together.

It is preferred that the hydrophobic thiol chain transfer agent is a thiol compound having a hydrocarbon group having 3 or more carbon atoms or a compound having a solubility in water at 25° C. of 10% or less. Specifically, thiol chain transfer agents such as butane thiol, octane thiol, decane thiol, dodecane thiol, hexadecane thiol, octadecane thiol, cyclohexyl mercaptan, thiophenol, octyl thioglycolate, octyl 2-mercaptopropionate, octyl 3-mercaptopropionate, mercaptopropionic acid 2-ethylhexyl ester, octanoic acid 2-mercaptoethyl ester, 1,8-dimercapto-3,6-dioxaoctane, decane trithiol, and dodecyl mercaptan are preferred, for example.

The hydrophobic thiol chain transfer agents may be used together with one or two or more of the hydrophilic thiol chain transfer agents as necessary.

As the hydrophilic thiol chain transfer agent, for example, mercaptoethanol, thioglycerol, thioglycolic acid, mercaptopropionic acid, 2-mercaptopropionic acid, 3-mercaptopropionic acid, thiomalic acid, 2-mercaptoethane sulfonic acid, and salts thereof are preferred.

As the chain transfer agent, one or two or more non-thiol chain transfer agents may also be used, or the non-thiol chain transfer agent and the thiol chain transfer agent may be used together.

As the non-thiol chain transfer agent, for example, primary alcohols such as 2-aminopropane-1-ol; secondary alcohols such as isopropanol; and lower oxides and salts thereof such as phosphorous acid and hypophosphorous acid, and salts thereof (sodium hypophosphite, potassium hypophosphite, and so on), sulfurous acid, bisulfite, dithionous acid and metabisulfite, and salts thereof (sodium sulfite, sodium hydrogen sulfite, sodium dithionite, sodium metabisulfite, potassium sulfite, potassium hydrogen sulfite, potassium dithionite, potassium metabisulfite, and so on) are preferred.

It is preferred that a continuous charging method such as dropping and separate charging is applied as a method of adding the chain transfer agent to a reaction vessel. Moreover, the chain transfer agent may be introduced alone into the reaction vessel or may be blended in advance with the unsaturated monomer having an oxyalkylene group which constitutes the monomer component or with the solvent or the like.

Here, when the polymerization is carried out using the thiol chain transfer agent, the thiol chain transfer agent sometimes remains after the polymerization. It is preferred from the standpoint of a working environment or the like in actual use that the amount of the residual thiol chain transfer agent is within the above-described range of the amount of the thiol group in the poly(carboxylic acid) polymer to be obtained.

Moreover, the polymerization can be carried out by a batch or a continuous system.

The polymerization condition such as the polymerization temperature in the polymerization step is appropriately determined by the polymerization method, the solvent, the polymerization initiator, the chain transfer agent, or the like to be used, however the polymerization temperature is preferably usually 40° C. or more, and the polymerization temperature is preferably 150° C. or less. Here, since it is preferable that the polymerization temperature is higher in order to reduce the amount of the residual thiol chain transfer agent, the polymerization temperature is more preferably, 80° C. or more, further more preferably 90° C. or more. And the polymerization temperature is more preferably 120° C. or less, further more preferably 100° C. or less.

Moreover, it is also preferred in the present invention to adjust the molecular weight of the poly(carboxylic acid) polymer by adjusting the amount of the polymerization initiator as described above. Such a method is preferable as a method of obtaining the poly(carboxylic acid) polymer of the present invention without using a chain transfer agent. In the case of adjusting the molecular weight by adjusting the amount of the polymerization initiator, the amount of the polymerization initiator is preferably usually 1 mol % or more based on 100 mol % of the monomer component, and the amount of the polymerization initiator is preferably 60 mol % or less. Here, since it is preferable the amount of the polymerization initiator is larger in order to adjust the molecular weight, the amount of the polymerization initiator is more preferably, 5 mol % or more, further more preferably 10 mol % or more. Moreover, the amount of the polymerization initiator is more preferably, 40 mol % or less, further more preferably 30 mol % or less.

Any of the monomer component, the chain transfer agent, and the polymerization initiator that can be used in the polymerization step may be used as it is or may be used as a solution in which each of the monomer component, the chain transfer agent, and the polymerization initiator is dissolved in a solvent such as water, an alcohol, a ketone, a hydrocarbon, or an ester (the monomer component-containing solution, the chain transfer agent-containing solution, and the polymerization initiator-containing solution). Among these solutions, it is preferable to use an aqueous solution of which solvent is water. Moreover, the monomer component-containing solution, the chain transfer agent-containing solution, and the polymerization initiator-containing solution may be added separately to the reaction vessel, or a solution in which two of the solutions are blended may be added to the reaction vessel.

Here, it is preferable that the polymerization initiator-containing solution is added to the reaction vessel after the addition of the thiol chain transfer agent-containing solution is completed in order to reduce the amount of the residual thiol chain transfer agent. When the addition of the thiol chain transfer agent-containing solution and the addition of the polymerization initiator-containing solution are started simultaneously, the ratio of the addition time for the polymerization initiator-containing solution to the addition time for the thiol chain transfer agent-containing solution (the addition time for the polymerization initiator-containing solution/the addition time for the thiol chain transfer agent-containing solution) is preferably 1.5 or more. The ratio is more preferably 1.75 or more.

Moreover, the addition time for the polymerization initiator-containing solution after the addition of the thiol chain transfer agent-containing solution is completed is 2 hours or more. More preferably, the addition time for the polymerization initiator-containing solution after the addition of the thiol chain transfer agent-containing solution is completed is 3 hours or more.

It is preferred in the present invention to make the ratio of the addition time for the polymerization initiator to the addition time for the thiol chain transfer agent equal to or more than the predetermined value or to increase the polymerization temperature in order to reduce the amount of the residual thiol chain transfer agent as described above. Thereby, it becomes possible to obtain the poly(carboxylic acid) polymer in which the amount of the residual thiol group is reduced to a level equal to or less than the particular level with high efficiency. Namely, an embodiment in which the polymerization is carried out so that the ratio of the addition time for the polymerization initiator to the addition time for the thiol chain transfer agent becomes equal to or more than the above-described predetermined value and/or an embodiment in which the polymerization is carried out by setting the polymerization temperature to 80° C. or more as described above are preferable embodiments as a production method of the poly(carboxylic acid) polymer of the present invention.

### [Hydraulic Material Additive]

The poly(carboxylic acid) polymer of the present invention is preferred as the main component of the hydraulic material additive. As described here, the hydraulic material additive containing the poly(carboxylic acid) polymer for a hydraulic material additive is also one of the present inventions.

Here the hydraulic material additive is an additive that is used for a hydraulic material such as, for example, cement such as Portland cement, blast furnace cement, silica cement, fly ash cement, and alumina cement; and gypsum such as natural gypsum and byproduct gypsum, and representative examples of the hydraulic material additive include a concrete admixture and a dispersant for gypsum. The concrete admixture and the dispersant for gypsum containing the poly(carboxylic acid) polymer are included in the preferred embodiments of the present invention.

### <Concrete Admixture>

The concrete admixture containing the poly(carboxylic acid) polymer can be used by adding the concrete admixture to a cement composition such as cement paste, mortar, and concrete. It is preferred that the cement composition contains cement and water, and further contains aggregate such as fine aggregate and coarse aggregate as necessary. Namely, the cement composition containing a concrete admixture containing the poly(carboxylic acid) polymer, cement, and water is one of the preferred embodiments of the present invention.

Examples of the cement in the cement composition include Portland cement (normal, high early strength, ultrahigh early strength, moderate heat, sulfate-resistant, and low alkaline types thereof); various types of mixed cement (blast furnace cement, silica cement, and fly ash cement); white Portland cement; alumina cement; ultrarapid hardening cement (1-clinker rapid hardening cement, 2-clinker rapid hardening cement, and magnesium phosphate cement); cement for grout; oil well cement; low heat cement (low heat type blast furnace cement, fly ash-mixed low heat type blast furnace cement, and high belite content cement); ultrahigh strength cement; cement solidifying material; and ecocement (cement produced from one or more of the incineration ash of city waste and the incineration ash of sewage sludge as a raw material), and in addition to the above cement, the cement obtained by adding fine particles or gypsum such as blast furnace slag, fly ash, cinder ash, clinker ash, husk ash, silica fume, silica powder, limestone powder to the above cement.

Moreover, examples of the aggregate include gravel, crushed stone, water granulated slag, recycled aggregate, and in addition to the above aggregate, refractory aggregate made from silica stone, clay, zircon, high-alumina, silicon carbide, graphite, chromium, chrome-magnesite, magnesia, or the like.

As the unit water content per m³, the amount of cement used, and the water/cement ratio (mass ratio) of the cement composition, it is preferred to make, for example, the unit water content 100 to 185 kg/m³, the amount of cement used 200 to 800 kg/m³, and the water/cement ratio (mass ratio)=0.1 to 0.7, more preferably the unit water content 120 to 175 kg/m³, the amount of cement used 250 to 800 kg/m³, and the water/cement ratio (mass ratio)=0.2 to 0.65. As described here, the hydraulic material additive containing the poly(carboxylic acid) polymer of the present invention can be used in a wide range from lean mix to rich mix, and can be used in a region of a high water-reducing ratio, namely the region of the low water/cement ratio such as the water/cement ratio (mass ratio)=0.15 to 0.5 (preferably 0.15 to 0.4). Moreover, the hydraulic material additive containing the poly(carboxylic acid) polymer of the present invention is effective for both of the high strength concrete having a large unit cement content and a small water/cement ratio and the lean-mix concrete having a unit cement content of 300 kg/m³ or less.

The concrete admixture can exhibit fluidity, retention, and workability with good balance and high performance even in a high water-reducing ratio region, has excellent workability, therefore can be effectively used for ready-mixed concrete, concrete for a concrete secondary product (precast concrete), concrete for centrifugal forming, concrete for vibration compaction, steam-cured concrete, spraying concrete, and so on, and is further effective for mortar or concrete for which high level of fluidity is required such as medium-fluidity concrete (concrete having a slump value in the range of 22 to 25 cm), high-fluidity concrete (concrete having a slump value of 25 cm or more and a slump flow value in the range of 50 to 70 cm), self-filling concrete, and a self-leveling material.

When the concrete admixture is used for the cement composition, it is preferable that the blending ratio of the poly(carboxylic acid) polymer that is an essential component is set so as to become 0.01 to 10 mass % in terms of the solid content based on 100 mass % of the total mass of the cement. The performance of the cement composition becomes more sufficient by the blending ratio of the poly(carboxylic acid) polymer being 0.01 mass % or more. Moreover, when the blending ratio of the poly(carboxylic acid) polymer exceeds 10 mass %, the effect of poly(carboxylic acid) polymer substantially reaches the limit, however the cement composition becomes more advantageous from the standpoint of economy by the blending ratio of the poly(carboxylic acid) polymer being 10 mass % or less. The blending ratio of the poly(carboxylic acid) polymer is more preferably 0.02 to 8 mass %, further more preferably 0.05 to 6 mass %.

Moreover, the concrete admixture can be used in combination with another additive for cement. As another additive for cement, one or two or more of the additives or the like for cement, for example, as shown below can be used. Above all, it is particularly preferable to use an oxyalkylene defoaming agent or an AE agent together with the additives for cements.

In addition, it is preferred that the addition ratio of the additive for cement is made 0.0001 to 10 weight parts based on 100 weight parts of the solid content of the poly(carboxylic acid) polymer.

(1) Water soluble polymer materials: polymerized products of unsaturated carboxylic acids such as polyacrylic acid (sodium polyacrylate), polymethacrylic acid (sodium polymethacrylate), polymaleic acid (sodium polymaleate), and sodium salts of copolymerized products of acrylic acid and maleic acid; polymers of polyoxyethylenes or polyoxypropylenes, or the copolymers thereof such as polyethylene glycol and polypropylene glycol; non-ionic cellulose ethers such as methyl cellulose, ethyl cellulose, hydroxymethyl cellulose, hydroxyethyl cellulose, carboxymethyl cellulose, carboxyethyl cellulose, and hydroxypropyl cellulose; polysaccharides produced by microbial fermentation such as yeast glucan, xanthan gum, β-1,3 glucans (which may be straight chain form or branched chain form, and examples include curdlan, paramylon, pachyman, scleroglucan, and laminaran); polyacrylamides; polyvinyl alcohols; starch; starch phosphate; sodium alginate; gelatin; copolymers of acrylic acids having an amino group in the molecule and quaternary compounds thereof, and so on.
(2) Polymer emulsions
(3) Retarders: oxycarboxylic acids and salts thereof such as gluconic acid, malic acid, or citric acid, and inorganic salts thereof such as sodium, potassium, calcium, magnesium, ammonium, and triethanolamine salts or organic salts thereof; sugar alcohols such as glucose, fructose, galactose, saccharose, and sorbitol; magnesium silicofluoride; phosphoric acid and salts thereof or boric acid esters; aminocarboxylic acids and salts thereof; alkali soluble proteins; humic acid; tannic acid; phenol; polyhydric alcohols such as glycerin; phosphonic acid and derivatives thereof such as aminotri(methylenephosphonic acid), 1-hydroxyethylidene-1,1-diphosphonic acid, ethylenediaminetetra(methylenephosphonic acid), diethylenetriaminepenta(methylenephosphonic acid), and alkali metal salts and alkaline earth metal salts thereof.
(4) Early strengthening agents/accelerators: soluble calcium salts such as calcium chloride, calcium nitrite, calcium nitrate, calcium bromide, and calcium iodide; alkanolamines; alumina cement; and calcium aluminate silicate, and so on.
(5) Mineral oil defoaming agents: kerosene, liquid paraffin, and so on.
(6) Oil and fat defoaming agents: animal and vegetable oils, sesame oil, castor oil, alkylene oxide adducts thereof, and so on.
(7) Fatty acid defoaming agents: oleic acid, stearic acid, alkylene oxide adducts thereof, and so on.
(8) Fatty acid ester defoaming agents: glycerinmonoricinoleate, alkenyl succinic acid derivatives, sorbitol monolaurate, sorbitol trioleate, natural wax, and so on.
(9) Oxyalkylene defoaming agents: polyoxyalkylenes such as (poly)oxyethylene (poly)propylene adducts; (poly)oxyalkyl ethers such as diethylene glycol heptyl ether, polyoxyethylene oleyl ether, polyoxypropylene butyl ether, polyoxyethylene polyoxypropylene-2-ethylhexyl ether, and oxyethylene oxypropylene adducts of higher alcohols having 12 to 14 carbon atoms; (poly)oxyalkylene (alkyl)aryl ethers such as polyoxypropylene phenyl ether and polyoxyethylene nonylphenyl ether; acetylene ethers obtained by addition polymerization of alkylene oxides to acetylene alcohols such as 2,4,7,9-tetramethyl-5-decine-4,7-diol, 2,5-dimethyl-3-hexyne-2,5-diol, and 3-methyl-1-butyn-3-ol; (poly)oxyalkylene fatty acid esters such as diethylene glycol oleate, diethylene glycol laurate, and ethylene glycol distearate; (poly)oxyalkylene sorbitan fatty acid esters such as polyoxyethylene sorbitan monolaurate and polyoxyethylene sorbitan trioleate; (poly)oxyalkylene alkyl(aryl)ether sulfuric acid ester salts such as sodium polyoxypropylene methyl ether sulfate and sodium polyoxyethylene dodecyl phenol ether sulfate; (poly)oxyalkylene alkyl phosphoric acid esters such as (poly)oxyethylene stearyl phosphate; (poly)oxyalkylene alkyl amines such as polyoxyethylene lauryl amine; polyoxyethylene alkylene amides, and so on.
(10) Alcohol defoaming agents: octyl alcohol, hexadecyl alcohol, acetylene alcohol, glycols, and so on.
(11) Amide defoaming agents: acrylate polyamines and so on.
(12) Phosphate defoaming agents: tributyl phosphate, sodium octyl phosphate, and so on.
(13) Metal soap defoaming agents: aluminum stearate, calcium oleate, and so on.
(14) Silicone defoaming agents: dimethyl silicone oils, silicone pastes, silicone emulsions, organically modified polysiloxane (polyorganosiloxanes such as dimethylpolysiloxane), fluorosilicone oils, and so on.
(15) AE agents: resin soap, saturated or unsaturated fatty acids, sodium hydroxy stearate, lauryl sulfate, ABS (alkylbenzene sulfonic acid), LAS (linear alkylbenzene sulfonic acid), alkane sulfonates, polyoxyethylene alkyl(phenyl)ether, polyoxyethylene alkyl(phenyl)ether sulfonic acid ester and salts thereof, polyoxyethylene alkyl(phenyl)ether phosphoric acid ester and salts thereof, protein materials, alkenyl sulfosuccinic acids, α-olefin sulfonates, and so on.
(16) Other surfactants: aliphatic monohydric alcohols having 6 to 30 carbon atoms in the molecule such as octadecyl alcohol and stearyl alcohol, alicyclic monohydric alcohols having 6 to 30 carbon atoms in the molecule such as abietyl alcohol, monovalent mercaptans having 6 to 30 carbon atoms in the molecule such as dodecyl mercaptan, alkylphenols having 6 to 30 carbon atoms in the molecule such as nonylphenol, amines having 6 to 30 carbon atoms in the molecule such as dodecylamine, polyalkylene oxide derivatives obtained by adding 10 moles or more of an alkylene oxide such as ethylene oxide and propylene oxide to a carboxylic acid having 6 to 30 carbon atoms in the molecule such as lauric acid and stearic acid; alkyl diphenyl ether sulfonic acid salts in which two phenyl groups each having a sulfone group which may have an alkyl group or an alkoxyl group as a substituent are bonded so as to form an ether bond; various anionic surfactants; various cationic surfactants such as alkylamine acetates and alkyl trimethyl ammonium chlorides; various nonionic surfactants; various amphoteric surfactants, and so on.
(17) Waterproofing agents: fatty acids (salts), fatty acid esters, oils and fats, silicon, paraffin, asphalt, wax, and so on.
(18) Corrosion inhibitors: nitrites, phosphates, zinc oxide, and so on.
(19) Crack-reducing agents: polyoxyalkyl ethers; alkanediols such as 2-methyl-2,4-pentanediol, and so on.
(20) Expanding materials: ettringites, coal, and so on.

Examples of the other additives for cement include a wetting agent for cement, a thickening agent, a separation-reducing agent, a flocculant, dry shrinkage-reducing agent, a strength-enhancing agent, self-leveling agent, a corrosion inhibitor, a colorant, a fungicide, blast furnace slag, fly ash, cinder ash, clinker ash, husk ash, silica fume, silica powder, and gypsum.

### <Dispersant for Gypsum>

The poly(carboxylic acid) polymer of the present invention is also suitably used for a dispersant for gypsum. Gypsum in the present invention includes, for example, gypsum hemihydrate, gypsum dihydrate, anhydrous gypsum, and besides, byproduct gypsum such as phosphogypsum and fluorogypsum. Various gypsum molded bodies can be suitably obtained by using the poly(carboxylic acid) polymer for a dispersant for gypsum. Examples of the gypsum molded body include a gypsum board, gypsum plaster, and a gypsum block.

The dispersant for gypsum containing the poly(carboxylic acid) polymer may further contain an appropriate amount of various additives such as a foaming agent, an accelerator for stucco, and aqueous slurry or solution of paper pulp.

Examples of the foaming agent include a powder of aluminum, zinc, magnesium, and a silicon alloy, and the aluminum powder is preferable.

Examples of the accelerator for stucco include a ball mill accelerator (BMA), calcium chloride, sodium bicarbonate, and potassium sulfate.

The aqueous slurry or solution of paper pulp contains water and a paper fiber (paper pulp) and may contain cone starch and/or potassium carbonate.

Moreover, a retarder may be optionally contained in the solution of paper pulp and can be used together with the accelerator for the purpose of adjusting the hardening time of the gypsum composition.

When the hydraulic material additive containing the poly(carboxylic acid) polymer is used for a hydraulic material composition containing a hydraulic material other than cement (such as gypsum), it is preferable that the blending ratio of the poly(carboxylic acid) polymer that is an essential component is set so as to become 0.005 to 5 mass % in terms of the solid content based on 100 mass % of the total mass of the hydraulic materials such as gypsum. The performance of the hydraulic material composition becomes more sufficient by the blending ratio of the poly(carboxylic acid) polymer being 0.005 mass % or more. Moreover, when the blending ratio of the poly(carboxylic acid) polymer exceeds 5 mass %, the effect of the poly(carboxylic acid) polymer substantially reaches the limit, however the hydraulic material composition becomes more advantageous from the standpoint of economy by the blending ratio of the poly(carboxylic acid) polymer being 5 mass % or less. Moreover, it becomes possible to suppress the delay of the hardening time more sufficiently by the blending ratio of the poly(carboxylic acid) polymer being 5 mass % or less. More preferably, the blending ratio of the poly(carboxylic acid) polymer is 0.01 to 3 mass %.

### Advantageous Effects of Invention

The poly(carboxylic acid) polymer for a hydraulic material additive of the present invention comprises the above-described constitution, is excellent in dispersion performance for a hydraulic material, workability and stability of quality. Therefore, a hydraulic material additive such as a concrete admixture and a dispersant for gypsum containing the poly(carboxylic acid) polymer is extremely useful in a civil engineering/architecture field and so on.

### DESCRIPTION OF EMBODIMENTS

Hereinafter, the present invention will be described more specifically giving Examples, however the present invention is not limited to these Examples only. Hereinafter, “%” means “mass %” unless otherwise noted. The weight average molecular weight (Mw) and the number average molecular weight (Mn) of the polymers obtained in the following production examples and so on were measured according to the above-described measurement condition.

Moreover, the amount of the thiol group in the polymer (the amount of the residual thiol group) was calculated by quantitatively measuring the remaining 3-mercaptopropionic acid by high performance liquid chromatography (LC) under the following condition.

### <LC Measurement Condition>

Used Column: Capsule pack AQ type manufactured by Shiseido Co., Ltd. (Functional group C18, particle size 3 μm, inside diameter 4.6 mm×length 100 mm)
Eluent: an eluent solution obtained by dissolving 50.7 g of sodium acetate trihydrate and 89.5 g of acetic acid in a mixed solvent of 18479.9 g of water and 380 g of acetonitrile is used.
Amount of sample injected: 100 μL of 2% eluent solution
Flow rate: 1.0 mL/min
Column temperature: 40° C.
Detector: 2996 photodiode array detector manufactured by Nihon Waters K.K. (detection wavelength 230 nm)
Analyzing software: Empower 2 manufactured by Nihon Waters K.K.

### Production Example 1

In a reaction vessel including a thermometer, a stirrer, a dropping funnel, a nitrogen inlet tube, and a reflux cooling tube (condenser), 240.2 g of water was charged, the temperature was raised to 90° C., and nitrogen substitution was carried out with nitrogen at a flow rate of 200 ml/min for 1 hour. Thereafter, a mixed solution (1) of 321.8 g of methoxy polyethylene glycol monomethacrylate (the average addition number of moles of ethylene oxide 25), 104.7 g of methacrylic acid, 12.1 g of 48% sodium hydroxide aqueous solution, 11.2 g of 3-mercaptopropionic acid, and 99.9 g of water and a mixed solution (2) of 6.5 g of sodium persulfate and 90.1 g of water were continuously dropped in 4 hours for the mixed solution (1) and in 6 hours for the mixed solution (2) to the reaction vessel kept at 90° C. After the temperature was kept at 90° C. for further 1 hour, 113.5 g of water was put into the reaction vessel to obtain a solution of a copolymer. The weight average molecular weight of the obtained copolymer was 8600, Mw/Mn was 1.42, and the amount of the residual thiol group was 0.5 μmol/g based on the amount of the polycarboxylic acid copolymer (the amount of the residual 3-mercaptopropionic acid was 53 ppm based on the amount of the polycarboxylic acid copolymer). In addition, the copolymer is referred to as the “copolymer (A1).” An aqueous solution containing the copolymer (A1) did not have a bad smell derived from the chain transfer agent.

### Production Example 2

A solution of a copolymer was obtained in the same manner as in Production Example 1 except that the addition time of the mixed solution (2) was made 7 hours and the polymerization temperature was made 95° C. The weight average molecular weight of the obtained copolymer was 8200, Mw/Mn was 1.41, and the amount of the residual thiol group was 0 mol/g based on the amount of the polycarboxylic acid copolymer (the amount of the residual 3-mercaptopropionic acid was 0 ppm based on the amount of the polycarboxylic acid copolymer). In addition, the copolymer is referred to as the “copolymer (A2).” An aqueous solution containing the copolymer (A2) did not have a bad smell derived from the chain transfer agent.

### Production Example 3

A solution of a copolymer was obtained in the same manner as in Production Example 1 except that the addition time of the mixed solution (2) was made 7 hours and the polymerization temperature was made 92° C. The weight average molecular weight of the obtained copolymer was 8300, Mw/Mn was 1.42, and the amount of the residual thiol group was 0 μmol/g based on the amount of the polycarboxylic acid copolymer (the amount of the residual 3-mercaptopropionic acid was 0 ppm based on the amount of the polycarboxylic acid copolymer). In addition, the copolymer is referred to as the “copolymer (A3).” An aqueous solution containing the copolymer (A3) did not have a bad smell derived from the chain transfer agent.

### Production Example 4

A solution of a copolymer was obtained in the same manner as in Production Example 1 except that the addition time of the mixed solution (2) was made 7 hours. The weight average molecular weight of the obtained copolymer was 8000, Mw/Mn was 1.40, and the amount of the residual thiol group was 0 μmol/g based on the amount of the polycarboxylic acid copolymer (the amount of the residual 3-mercaptopropionic acid was 0 ppm based on the amount of the polycarboxylic acid copolymer). In addition, the copolymer is referred to as the “copolymer (A4).” An aqueous solution containing the copolymer (A4) did not have a bad smell derived from the chain transfer agent.

### Production Example 5

In a reaction vessel including a thermometer, a stirrer, a dropping funnel, a nitrogen inlet tube, and a reflux cooling tube (condenser), 223.3 g of water was charged, the temperature was raised to 90° C., and nitrogen substitution was carried out with nitrogen at a flow rate of 200 ml/min for 1 hour. Thereafter, a mixed solution (3) of 330.3 g of methoxy polyethylene glycol monomethacrylate (the average addition number of moles of ethylene oxide 25), 97.3 g of methacrylic acid, 11.3 g of 48% sodium hydroxide aqueous solution, 10.6 g of 3-mercaptopropionic acid, and 92.9 g of water and a mixed solution (4) of 6.4 g of sodium persulfate and 83.8 g of water were continuously dropped in 4 hours for the mixed solution (3) and in 7 hours for the mixed solution (4) to the reaction vessel kept at 90° C. After the temperature was kept at 90° C. for further 1 hour, 144.2 g of water was put into the reaction vessel to obtain a solution of a copolymer. The weight average molecular weight of the obtained copolymer was 8200, Mw/Mn was 1.41, and the amount of the residual thiol group was 0 μmol/g based on the amount of the polycarboxylic acid copolymer (the amount of the residual 3-mercaptopropionic acid was 0 ppm based on the amount of the polycarboxylic acid copolymer). In addition, the copolymer is referred to as the “copolymer (A5).” An aqueous solution containing the copolymer (A5) did not have a bad smell derived from the chain transfer agent.

### Production Example 6

In a reaction vessel including a thermometer, a stirrer, a dropping funnel, a nitrogen inlet tube, and a reflux cooling tube (condenser), 264.7 g of water, 396.4 g of an ethylene oxide 50 moles adduct of 3-methyl-3-butene-1-ol, and 0.7 g of acrylic acid were charged, the temperature was raised to 90° C., and nitrogen substitution was carried out with nitrogen at a flow rate of 500 ml/min for 1 hour. Thereafter, a mixed solution (5) of 52.9 g of acrylic acid and 59.7 g of water, a mixed solution (6) of 14.1 g of 3-mercaptopropionic acid and 85.9 g of water, and a mixed solution (7) of 10.5 g of ammonium persulfate and 115.1 g of water were continuously dropped in 3 hours for the mixed solution (5), in 3 hours for the mixed solution (6), and in 5 hours for the mixed solution (7) to the reaction vessel kept at 90° C. The temperature was kept at 90° C. for further 1 hour to obtain a solution of a copolymer. The weight average molecular weight of the obtained copolymer was 9000, Mw/Mn was 1.31, and the amount of the residual thiol group was 0.9 μmol/g based on the amount of the polycarboxylic acid copolymer (the amount of the residual 3-mercaptopropionic acid was 96 ppm based on the amount of the polycarboxylic acid copolymer). In addition, the copolymer is referred to as the “copolymer (A6).” An aqueous solution containing the copolymer (A6) did not have a bad smell derived from the chain transfer agent.

### Production Example 7

In a reaction vessel including a thermometer, a stirrer, a dropping funnel, a nitrogen inlet tube, and a reflux cooling tube (condenser), 264.7 g of water, 396.4 g of an ethylene oxide 50 moles adduct of methallyl alcohol, and 0.7 g of acrylic acid were charged, the temperature was raised to 90° C., and nitrogen substitution was carried out with nitrogen at a flow rate of 500 ml/min for 1 hour. Thereafter, a mixed solution (8) of 52.9 g of acrylic acid and 59.7 g of water, a mixed solution (9) of 14.1 g of 3-mercaptopropionic acid and 85.9 g of water, and a mixed solution (10) of 10.5 g of ammonium persulfate and 115.1 g of water were continuously dropped in 3 hours for the mixed solution (8), in 3 hours for the mixed solution (9), and in 5 hours for the mixed solution (10) to the reaction vessel kept at 90° C. The temperature was kept at 90° C. for further 1 hour to obtain a solution of a copolymer. The weight average molecular weight of the obtained copolymer was 8800, Mw/Mn was 1.26, and the amount of the residual thiol group was 0.67 μmol/g based on the amount of the polycarboxylic acid copolymer (the amount of the residual 3-mercaptopropionic acid was 71 ppm based on the amount of the polycarboxylic acid copolymer). In addition, the copolymer is referred to as the “copolymer (A7).” An aqueous solution containing the copolymer (A7) did not have a bad smell derived from the chain transfer agent.

### Production Example 8

In a reaction vessel including a thermometer, a stirrer, a dropping funnel, a nitrogen inlet tube, and a reflux cooling tube (condenser), 400.0 g of water was charged, the temperature was raised to 95° C., and nitrogen substitution was carried out with nitrogen at a flow rate of 200 ml/min for 1 hour. Thereafter, a mixed solution (11) of 150.9 g of methoxy polyethylene glycol monomethacrylate (the average addition number of moles of ethylene oxide 10), 49.1 g of methacrylic acid, 3.8 g of 48% sodium hydroxide aqueous solution, and 290.0 g of water and a mixed solution (12) of 30.2 g of sodium persulfate and 76.1 g of water were continuously dropped in 3 hours for the mixed solution (11) and in 4.5 hours for the mixed solution (12) to the reaction vessel kept at 95° C. The temperature was kept at 95° C. for further 1 hour to thereafter obtain a solution of a copolymer. The weight average molecular weight of the obtained copolymer was 9300, Mw/Mn was 1.76, and the amount of the residual thiol group was 0 μmol/g. In addition, the copolymer is referred to as the “copolymer (A8).” An aqueous solution containing the copolymer (A8) did not have a bad smell derived from the chain transfer agent.

### Comparative Production Example 1

A solution of a copolymer was obtained in the same manner as in Production Example 1 except that the addition time of the mixed solution (2) was made 5 hours. The weight average molecular weight of the obtained copolymer was 8400, Mw/Mn was 1.41, and the amount of the residual thiol group was 6.3 μmol/g based on the amount of the polycarboxylic acid copolymer (the amount of the residual 3-mercaptopropionic acid was 669 ppm based on the amount of the polycarboxylic acid copolymer). In addition, the copolymer is referred to as the “copolymer (B1).” An aqueous solution containing the copolymer (B1) had a bad smell derived from the chain transfer agent.

### Comparative Production Example 2

A solution of a copolymer was obtained in the same manner as in Production Example 1 except that the addition time of the mixed solution (2) was made 5 hours and the polymerization temperature was made 80° C. The weight average molecular weight of the obtained copolymer was 7700, Mw/Mn was 1.39, and the amount of the residual thiol group was 20.7 μmol/g based on the amount of the polycarboxylic acid copolymer (the amount of the residual 3-mercaptopropionic acid was 2196 ppm based on the amount of the polycarboxylic acid copolymer). In addition, the copolymer is referred to as the “copolymer (B2).” An aqueous solution containing the copolymer (B2) had a bad smell derived from the chain transfer agent.

### Comparative Production Example 3

A solution of a copolymer was obtained in the same manner as in Production Example 1 except that the addition time of the mixed solution (2) was made 7 hours and the polymerization temperature was made 80° C. The weight average molecular weight of the obtained copolymer was 7900, Mw/Mn was 1.41, and the amount of the residual thiol group was 10.6 μmol/g based on the amount of the polycarboxylic acid copolymer (the amount of the residual 3-mercaptopropionic acid was 1129 ppm based on the amount of the polycarboxylic acid polymer). In addition, the copolymer is referred to as the “copolymer (B3).” An aqueous solution containing the copolymer (B3) had a bad smell derived from the chain transfer agent.

### Examples 1 to 4

Each of the copolymer (A1), the copolymer (A2), the copolymer (A6), and the copolymer (A7) obtained in the above-described Production Examples was blended according to the following combination to make a dispersant for cement, and the mortar flow values immediately after the mixing and with time were evaluated. The results are shown in Table 1.

Moreover, the performance evaluation as a dispersant for cement of each of the copolymers (A3) to (A5), the copolymer (A8), and the copolymers (B1) to (B3) was carried out similarly under the following condition to find that the initial flow values and the flow values after 30 minutes and 60 minutes were almost the same as the flow values of copolymers (A1) and (A2).

### <Evaluation of Cement Dispersibility>

The mortar test was carried out under an environment at a temperature of 20° C.±1° C. and a relative humidity of 60%±10%.

The mortar combination was C/S/W=942 g/405 g/143 g.

In the formula,
C: silica fume cement (manufactured by Ube-Mitsubishi Cement Corporation),
S: pit sand from Kimitsu, Chiba Prefecture, and
W: aqueous solution of a copolymer of the present invention and a defoaming agent.

The aqueous solution of the polymer as W was weighed out by an amount of addition shown in Table 1, a defoaming agent MA-404 (manufactured by Pozzolith Bussan Co., Ltd.) was added thereto on an as-is basis by 10 mass % based on the solid content of the polymer, and water was further added thereto to make a predetermined amount of a sufficiently homogeneous solution. In Table 1, the amount of the cement added is represented by the mass % of the solid content of the polymer based on the mass of the cement.

A stainless steel beater (stirring blade) was attached to a Hobart type mortar mixer (model number N-50; manufactured by Hobart Corporation), and C was put into the mortar mixer and mixed at the first speed for 20 seconds. Further, W was put into the mortar mixer over 5 seconds while mixing was carried out at the first speed. After putting W into the mortar mixer, mixing was carried for 75 seconds, thereafter S was put into the mortar mixer over 20 seconds while mixing was carried out at the first speed, and mixing was further carried out for 70 seconds. Thereafter, the mixer was stopped, the mortar was scraped off for 20 seconds, and mixing was further carried out at the first speed for 120 seconds to prepare mortar.

The mortar was transferred from the mixing vessel to a 1 L polyethylene vessel, stirred 10 times with a spatula, and immediately after that, the mortar was put into a flow cone (described in JIS R5201-1997) placed on a flow table (described in JIS R5201-1997) so as to fill the flow cone half full and jabbed with a stick 15 times, further the mortar was put into the flow cone so as to completely fill the flow cone and jabbed with a stick 15 times, finally the deficiency to completely fill the flow cone was supplied, and the surface of the flow cone was leveled. Immediately after that, the flow cone was lifted vertically to be kept at a height of 15 cm from the table for 30 seconds. After keeping the flow cone, the flow cone was left standing still for 150 seconds, and the diameters of the spread mortar were measured at two points (the longest diameter (major axis) and the diameter forming an angle of 90° with the major axis), and the average value of the two diameters was determined as an initial flow value. The flow values immediately after the mortar preparation (initial), 30 minutes after the mortar preparation, and 60 minutes after the mortal preparation are shown in Table 1. In addition, the dispersibility is more excellent as the flow value is larger.

TABLE 1

| | | Amount of | Flow (mm) | | |
|---|---|---|---|---|---|
| | | addition % by | Ini- | 30 | 60 |
| | Copolymer | mass/cement | tial | minutes | minutes |
| Example 1 | Copolymer (A1) | 0.32 | 252 | 194 | 185 |
| Example 2 | Copolymer (A2) | 0.32 | 248 | 194 | 184 |
| Example 3 | Copolymer (A6) | 0.32 | 245 | 190 | 178 |
| Example 4 | Copolymer (A7) | 0.32 | 243 | 192 | 179 |

### INDUSTRIAL APPLICABILITY

The polycarboxylic acid copolymer for a hydraulic material additive and the hydraulic material additive of the present invention are excellent in dispersion performance for a hydraulic material, workability and stability of quality, and therefore is useful for various uses.

1. A poly(carboxylic acid) polymer for a hydraulic material additive,
wherein the polymer has a (poly)alkylene glycol chain, and the polymer has a weight average molecular weight (Mw) of 30000 or less, and an amount of a thiol group in the polymer of 2.4 mmol/g or less, and
wherein the thiol group in the polymer is derived from a thiol chain transfer agent.

2. The poly(carboxylic acid) polymer for a hydraulic material additive according to claim 1,
wherein the polymer is obtained by polymerizing a monomer component containing an unsaturated monomer having a (poly)oxyalkylene group.

3. The poly(carboxylic acid) polymer for a hydraulic material additive according to claim 1,
wherein the polymer is obtained by polymerizing a monomer component containing an unsaturated monomer having a (poly)oxyalkylene group and an unsaturated carboxylic acid monomer.

4. The poly(carboxylic acid) polymer for a hydraulic material additive according to claim 2,
wherein the unsaturated monomer having a (poly)oxyalkylene group is a compound represented by the following general formula (1): 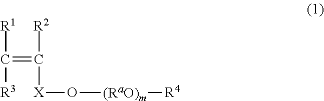
wherein R¹, R², and R³ are the same or different and represent a hydrogen atom or a methyl group; R⁴ represents a hydrogen atom or a hydrocarbon group having 1 to 20 carbon atoms; R^{a} are the same or different and represent an alkylene group having 2 to 18 carbon atoms; m represents an average addition number of moles of an oxyalkylene group represented by R^{a}O and is a number of 1 to 300; X represents a divalent alkylene group having 1 to 5 carbon atoms, represents a —CO— bond, or, when a group represented by R¹R³C═CR²— is a vinyl group, represents that the carbon atom and the oxygen atom bonded to X are directly bonded with each other; namely, X represents any one of a divalent alkylene group having 1 to 5 carbon atoms, a —CO— bond, and a direct bond (when the group represented by R¹R³C═CR²— is a vinyl group).

5. The poly(carboxylic acid) polymer for a hydraulic material additive according to claim 3,
wherein the unsaturated carboxylic acid monomer is an unsaturated monocarboxylic acid monomer.

6. The poly(carboxylic acid) polymer for a hydraulic material additive according to claim 1,
wherein the polymer has a weight average molecular weight of 10000 or less.

7. (canceled)

8. The poly(carboxylic acid) polymer for a hydraulic material additive according to claim 1,
wherein an amount of a thiol chain transfer agent in the polymer is 250 ppm or less.

9. A hydraulic material additive comprising a poly(carboxylic acid) polymer for a hydraulic material additive according to claim 1.

10. A hydraulic material comprising a hydraulic material additive according to claim 9.

11. The poly(carboxylic acid) polymer for a hydraulic material additive according to claim 4,
wherein the compound represented by the general formula (1) is a (poly)alkylene glycol ester monomer.

12. The poly(carboxylic acid) polymer for a hydraulic material additive according to claim 4,
wherein the compound represented by the general formula (1) is a (poly)alkylene glycol adduct of an unsaturated alcohol.

13. The poly(carboxylic acid) polymer for a hydraulic material additive according to claim 1,
wherein the amount of a thiol group in the polymer is 0.95 μmol/g or less.

14. The poly(carboxylic acid) polymer for a hydraulic material additive according to claim 1,
wherein the amount of a thiol group in the polymer is 0.5 μmol/g or less.

15. The poly(carboxylic acid) polymer for a hydraulic material additive according to claim 1,
wherein the amount of a thiol group in the polymer is 0.25 mmol/g or less.

16. The poly(carboxylic acid) polymer for a hydraulic material additive according to claim 1,
wherein the amount of a thiol group in the polymer is 0.05 mmol/g or less.
